(19) United States
(12) Patent Application Publication
(10) Pub. No.: US 2004/0210453 A1
(43) Pub. Date: Oct. 21, 2004

(54) Method for accepting and/or authenticating documents

(75) Inventors: Norbert Miller, Monchengladbach (DE); Peter Hoffges, Monchengladbach (DE); Erich Horn, Woburn, MA (US)

Correspondence Address: CANTOR COLBURN, LLP, 55 GRIFFIN ROAD SOUTH, BLOOMFIELD, CT, 06002

(73) Assignee: SCHEIDT & BACHMANN GMBH, Monchengladbach (DE)

(21) Appl. No.: 10/765,730

(22) Filed: Jan. 26, 2004

(30) Foreign Application Priority Data
Apr. 15, 2003 (DE) 103 17 397.8

(51) Int. Cl. G06F 17/60; H04K 1/00; H04L 9/00

(52) U.S. Cl. 705/1; 705/64

(57) ABSTRACT

The invention relates to a method for accepting and/or authenticating documents, especially banknotes, as well as a device for performing the method.

It is the object of the present invention to further develop a method of this kind for authenticating documents as well as a device such that the degree of safe authentication can be increased.

The invention suggests a method for accepting and/or authenticating documents, especially banknotes, wherein the document is fed to a verification unit by means of an input unit, the document is authenticated and released for further processing, and wherein the authentication process is performed with a combination of at least two different verification processes.

The invention relates to a method for accepting and/or authenticating documents, in particular banknotes, as well as a device for performing the procedure.

In trade a variety of payment systems, especially machines, are known with which a customer can purchase goods and/or services against payment by cash, vouchers or the like. The machine accepts the means of payment, verifies its value and validity, and feeds an authenticated means of payment to a storage device in which this means of payment is stored. Such payment systems are also frequently used for the purchase of tickets, for example for public transportation or the like.

Known payment systems, such as for example a sales machine for selling tickets for public transportation, generally contain an opening into which the means of payment can be inserted individually and consecutively. The individual means of payment such as banknotes or vouchers are verified and maintained in intermediate storage until the amount of the means payment that have been inserted corresponds to or exceeds the amount of the ticket.

In general the document or the banknote is transported into the inside of the machine by means of a transport mechanism, and is fed to a verification unit, in which the document is authenticated and released for further processing. An invalid document is rejected via the same or a separate opening. The disadvantage with known methods is that, especially with regard to banknotes, the machines apply only one verification method for authenticating the banknote. Banknotes as a rule contain several safety features, which would allow authentication with a great level of certainty.

It is therefore the object of the present invention to further develop a method of the aforementioned kind for authenticating documents, as well as a device, in such a way that the degree of safe authentication can be increased.

As a solution, the invention suggests a method for accepting and/or authenticating documents, especially banknotes, wherein the document is fed to a verification unit by means of an input unit, the document is authenticated and released for further processing, wherein authentication is performed by a combination of at least two different verification methods.

First, for example with respect to banknotes, the verification of different safety features allows a particularly high level of certainty to be achieved. This is particularly beneficial because banknotes generally have a considerably higher value than coins. An incorrect verification in which a banknote is detected as valid but is actually invalid, which would lead to an economic loss, becomes much more unlikely. In particular, verification methods can be combined to verify physically complete, different features of the document.

It is furthermore suggested that at least two verification methods from the group comprising especially size verification, magnetic verification, image verification, infrared verification, UV verification, and visual verification should be used. For example, a combination of size verification and magnetic verification can be used, especially when the document has magnetic properties. It is also possible, however, for several verification methods to be used, especially those that detect all features of the document. This way a particularly high certainty standard can be achieved. Any random selection and number of verification methods can be used.

It is furthermore suggested that the results of the verification method be compared. In this manner it can be achieved, for example, that a document is released only when all applied verification methods result in sufficient authentication.

Additionally, a visual verification can be conducted. In the case of a document that cannot be authenticated or a banknote that is found to be invalid, the document can be presented to an operator. For this purpose, the document can be recorded as an image and the image can be transmitted to an operator. In this, transmission would be accomplished via known communication devices.

It is further suggested that the visual verification can be conducted as a function of the value of the document. For example, it can be established that visual verification would not be conducted for every document, in order to keep the overall expense of visual verification low. In the case of banknotes, for example, it could be provided that visual verification would be conducted only for banknotes having a value of EURO 100 or US$ 100.

Visual verification can be conducted as a function of authentication certainty. It can be provided, for example, that in the case of an unclear result from one of the at least two verification methods, a visual examination would be provided. This can also be incorporated when verification methods supply opposing results. The probability of a positive authentication of an invalid document can be reduced considerably. Furthermore, the method pursuant to the invention offers the advantage that the cost of visual verification can be further reduced. For example, a combination of visual verification with other verification methods can be provided as a function of the amount and the authentication certainty.

It is further suggested that with a positive authentication the document is accepted. The document can beneficially be transported into a storage device that is provided. However, it can also be provided that the document is ejected again following positive authentication. In the case of a negative authentication it is suggested that acceptance of the document is declined. Such a document can either be fed to a separate storage device for invalid documents or ejected again. For this purpose, it can be transported to an incorporated ejection opening.

The invention moreover suggests a device for accepting and/or authenticating documents, especially banknotes, which comprises at least two verification stations performing different verification methods for authenticating the document and one computer unit for comparing the results of the verification stations. Each verification station can thus check a different safety feature, wherein the verification methods can be selected to be different and aligned with the safety feature that is to be verified. In this manner, very different features of the document can beneficially be verified in order to achieve a high level of authentication certainty.

Further benefits and features are revealed in the following description of an exemplary embodiment with respect to the corresponding drawing. The drawing is diagrammatic and serves only to explain the following exemplary embodiment and is not limiting. Within the framework of the present invention, individual features can also be combined into further embodiments.

The sole FIGURE shows in a diagrammatic view the course of a method pursuant to the invention.

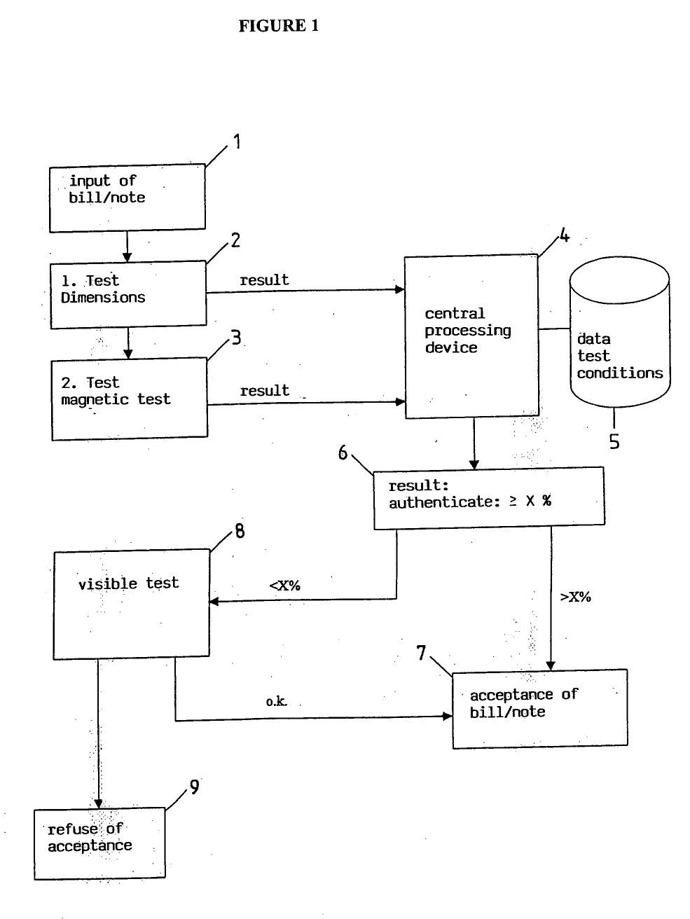

FIG. 1 shows, in a diagrammatic view, a flow chart of an exemplary embodiment of a method for accepting/authenticating banknotes. The banknotes are fed to an input unit 1, which is known from the prior art. From said input unit 1 the banknotes to be authenticated first reach a first verification station 2, which in the depicted example is size verification. After the size verification has been conducted, the banknotes are forwarded to a second verification station 3, in this case a magnetic examination to detect a magnetic dye that is imprinted on the banknote. The verification data obtained during the size verification and the magnetic verification processes of each individual banknote are supplied to a central computer unit 4. In this computer unit 4 verification specifications 5 are stored in the form of data sets. The results of the examinations that have been conducted are compared with these data sets. Based upon this comparison, the probability of authenticity 6 of the verified banknote is determined. If this value fulfills the specified criteria, then the central computer unit 4 initiates the acceptance 7 of the banknote. If the calculated probability does not meet the specified requirements, the central computer unit 4 initiates a visual examination 8 of the affected banknote. If the banknote passes the visual examination 8, its acceptance is released 7, otherwise acceptance is refused 9.

The exemplary embodiment serves only the purpose of explaining the present invention and does not limit it.

Legend:

1 Input unit

2 First verification station

3 Second verification station

4 Computer unit

5 Data set/Verification specifications

6 Determination of probability of authenticity

7 Accept banknote

8 Visual verification

9 Refuse acceptance of banknote

1. Method for authenticating documents, comprising:
feeding the document to a verification unit by means of an input unit, authenticating the document, and releasing the document for further processing,
wherein said
authenticating the document is performed with a combination of at least two different verification methods.

2. Method pursuant to claim 1, wherein the at least two verification methods are selected from the group comprising size verification, magnetic verification, image verification, infrared verification, UV verification, and visual verification.

3. Method pursuant to claim 1, wherein results of the verification methods are compared.

4. Method pursuant to claim 1, wherein a visual verification method is conducted.

5. Method pursuant to claim 4, wherein the visual verification method is performed as a function of the value of the document.

6. Method pursuant to claim 4, wherein the visual verification method is performed as a function of authentication certainty.

7. Method pursuant to claim 6, wherein the document is accepted with positive authentication and rejected with negative authentication.

8. Device for authenticating a document, comprising:
at least two verification stations, each of which performs a different verification process for authentication of the document, and
a computer unit for comparing results of the verification stations.
